(19) United States
(12) Patent Application Publication
(10) Pub. No.: US 2019/0295045 A1
(43) Pub. Date: Sep. 26, 2019

(54) Raw Material and/or Recycling System

(71) Applicants: Carsten Stöcker, Hilden (DE); Philipp Limbourg, Essen (DE); Markus Ludwig Rothkeppel, Essen (DE)

(72) Inventors: Carsten Stöcker, Hilden (DE); Philipp Limbourg, Essen (DE); Markus Ludwig Rothkeppel, Essen (DE)

(73) Assignee: innogy Innovation GmbH, Essen (DE)

(21) Appl. No.: 16/426,667

(22) Filed: May 30, 2019

Related U.S. Application Data
(63) Continuation of application No. PCT/EP2016/079247, filed on Nov. 30, 2016.

(51) Int. Cl. G06Q 10/00; H04L 29/08

(52) U.S. Cl. CPC G06Q 10/30; H04L 67/104

(57) ABSTRACT

A raw material and/or recycling system, including at least one tagging unit configured to provide at least one recyclable material element with at least one identifier. The system also includes at least one first peer-to-peer module assigned to the tagging unit and at least one peer-to-peer network having at least one peer-to-peer application. The first peer-to-peer module is configured to provide the provided identifier and at least one status parameter data set related to the recyclable material element to the peer-to-peer application. The peer-to-peer application includes at least one registering means executable upon provision of the provided identifier by at least a part of the nodes of the peer-to-peer network. The registering means is configured to register at least the recyclable material element by storing at least the provided identifier and the provided status parameter data set in at least one registry storage.

### CROSS-REFERENCE TO RELATED PATENT APPLICATIONS

This patent application is a continuation of PCT/EP2016/079247, filed Nov. 30, 2016, the entire teachings and disclosure of which are incorporated herein by reference thereto.

### FIELD

The invention relates to a raw material and/or recycling system comprising at least one tagging unit configured to provide at least one recyclable material element with at least one identifier. The invention relates also to a recyclable material element processing unit, a method for operating a raw material and/or recycling system and a peer-to-peer application.

### BACKGROUND

Raw material and/or recycling systems are widely used. Several different systems exist e.g. for different raw material(s) and recyclable material element(s), respectively. In order to operate such a system, recyclable material elements are centrally registered in a server. More particularly, each raw material element can be provided with an identifier by a client (e.g. a distributing entity of said recyclable material element). The client can transmit the identifier to the server and the identifier can be stored in the server.

One example of such a system is a bottle deposit system. A typical bottle deposit system 100 is shown in FIG. 1. The depicted raw material and/or recycling system 100 comprises at least one central server 102 having a registry database 108. A plurality of client entities 104.1 to 104.4 is connected to the server 102 via e.g. standard network(s). For instance, a first client entity 104.1 e.g. of a distributing entity comprises a tagging unit configured to provide a recyclable material element 106 in form of a container (e.g. a bottle) 106 with an identifier. The provided identifier is transmitted to the server 106 and stored in the registry database 108.

A further client in form of a delivery unit 104.2 (e.g. a shop) may dispense a container 106 and may report to the server 102 about the dispensing of said container 106. A further client 104.3 may be a return unit 104.3 configured to detect the return of a container 106 and e.g. configured to return a deposit e.g. to a user of the container 106.

Eventually, a client 104.4 in form of a recycling unit 104.4 may process the returned container 106 in a recycling step.

However, a drawback of these prior art systems is the complex mechanism required to securely process and track the containers. There is a plurality of system upheaval and/or interfaces. Further, according to prior art, a lot of manual interactions are required. In particular, the process and storage of confidential data is difficult and requires a high security efforts. Data privacy is especially difficult to achieve due to the movement of the containers. This also complicates access to the data by authorized entities (e.g. users).

In particular, a drawback of such a raw material and/or recycling system is the server-client structure of these systems. Usually, as described above, a central server is used for conducting e.g. a registering process. A further disadvantage of server-client structures of this kind, particularly the server (or platform), apart from the high transaction costs, is that the central instance or central server manages confidential data including e.g. user data, authorization data, provider data or the like. A persistent problem affecting the central instance is that of protecting the confidential data stored on one or more server(s) from access by unauthorized third parties. In particular, a high degree of security expenditure is required, in order to prevent said data from being tampered with. This in turn leads to even higher transaction costs. A further disadvantage is the complex and costly infrastructure for providing the described server-client structure.

Therefore, it is an object of the present invention to provide a raw material and/or recycling system, which enables to operate such a system more efficient and, at the same time, with a higher security level.

### BRIEF SUMMARY

The object is solved according to a first aspect of the present invention by a raw material and/or recycling according to the present disclosure. The raw material and/or recycling system comprises at least one tagging unit configured to provide at least one recyclable material element with at least one identifier. The system comprises at least one first peer-to-peer module assigned to the tagging unit. The system comprises at least one peer-to-peer network comprising at least one peer-to-peer application. The first peer-to-peer module is configured to provide the provided identifier and at least one status parameter data set related to the recyclable material element to the peer-to-peer application. The peer-to-peer application comprises at least one registering means executable upon provision of the provided identifier by at least a part of the nodes of the peer-to-peer network. The registering means is configured to register at least the recyclable material element by storing at least the provided identifier and the provided status parameter data set in at least one registry storage.

In contrast to prior art systems, registering recyclable material elements and maintaining their data can be conducted in a more efficient and more secure way by at least executing a registering means by at least a part (e.g. >1) of the nodes of a peer-to-peer network. In other words, a raw material and/or recycling system can be managed and controlled without a central instance but by a peer-to-peer application of a peer-to-peer network. By the fact that instead of a central server or a platform, a peer-to-peer network (also called a framework) undertakes the in particular tamper-proof controlling of the raw material and/or recycling system, by means of a peer-to-peer application, high security standards are achieved in that all computers (peer nodes or simply nodes) in the peer-to-peer network, at least a part of the nodes in the peer-to-peer network, at least monitor(s) preferably each process, in particular, by executing e.g. the registering means. Thereby, the transaction costs can be significantly reduced. No central, superior platform, server, cloud, etc. is required. The complexity of managing and controlling a raw material and/or recycling system can be significantly reduced. User data and other confidential data can be securely managed. Manual interactions can be reduced. Almost no system upheavals are provided.

A raw material and/or recycling system according to the present application is configured to enable an efficient recycling of any produced and/or used recyclable material element. A recyclable material element is any element (e.g. a liquid material or a solid material or gaseous material) which can (and should) be recycled. Non-exhaustive examples of typical recyclable material element comprises any kind of containers or packages, any kind of electronic devices, any kind of cloths, any kind of waste products in the manufacturing industry, plastic materials, chemicals, fuels, metals, biological substance, etc.

The present system comprises at least one recyclable material element processing unit at least in form of at least one tagging unit. The tagging unit is configured to provide at least identifier to at least one recyclable material element. This means that an identifier is (uniquely) associated and linked, respectively, with a recyclable material element. Preferably, each recyclable material element can be provided with a respective identifier. The identifier may be an unique identifier. This means that each recyclable material element of the system has an unique identifier and can be uniquely identified. For instance, an identifier can be provided by a peer-to-peer application comprising an identifier generating means and/or the tagging unit can comprise a identifier generating tool configured to generate (unique) identifier(s) e.g. in accordance with predefinable rule(s).

The tagging unit may be part of a production entity and/or distributing entity and/or a recycling entity. For instance, newly produced or recycled recyclable material element(s) can be provided with an identifier by the tagging unit.

Furthermore, at least one first peer-to-peer module is assigned to the tagging unit. For instance, each recyclable material element processing unit of a system may comprise a separate peer-to-peer module. Preferably, each peer-to-peer module is uniquely assigned to a respective recyclable material element processing unit. For instance, a recyclable material element processing unit, in particular, a tagging unit can comprise a peer-to-peer module. Preferably, the first peer-to peer module can be integrated in the tagging unit.

It is also possible that a communication connection is provided between the tagging unit (or another recyclable material element processing unit) and a (remotely arranged) peer-to-peer module assigned to said tagging unit (or the other recyclable material element processing unit). This means that the peer-to-peer module can at least communicate and/or act on behalf of the tagging unit. For example, the peer-to-peer module can be partly formed by a separate processing device, such as mobile communication device (e.g. mobile phone, mobile computer, etc.), or it can run on a remote stationary processing device (e.g. in a data center). In case of a mobile communication device or a remote processing device, the at least one tagging unit may have a secure communication channel to the processing device (or mobile communication device) of the data center and the processing device itself may have a connection to the peer-to-peer network. In an embodiment, the remote processing device may be a gateway to the peer-to-peer network. This means that the tagging unit can securely communicate via its peer-to-peer module and the gateway to the peer-to-peer network.

In comparison to a client server system in which a server provides a service (registering and e.g. tracking process) and a client uses the service, these roles are cancelled in the present peer-to-peer network. Each participant (e.g. node) of the peer-to-peer network can use a service and the like and offer such a service. In particular, a peer-to-peer network is self-determined and/or self-organized (without any higher-level units). In the present case, preferably each node and computer, respectively, of the peer-to-peer network comprises the (same) peer-to-peer application. This means that a plurality of nodes comprise the same executable means and execute such a means upon receipt of a trigger.

The peer-to-peer module is configured to communicate, e.g. send/receive messages to/from the peer-to-peer application. The peer-to-peer module may be a peer and node, respectively, of the peer-to-peer network. The peer-to-peer module provides at least an identifier and a status parameter data set to the peer-to-peer application. A status parameter data set may comprise at least one parameter (indirectly or directly) related to the status of the recyclable material element. Examples of status parameters are location of the recyclable material element (at a specific time), identifier of a recyclable material element processing unit which has been passed by the recyclable material element, quality or condition (comprising e.g. damaged, new, recycled, used, reused, filled, etc.) of a recyclable material element (at a specific time), etc.

The present peer-to-peer application comprises at least one registering means, preferably, in form of a smart contract. The registering means may be executable by a part of the nodes, preferably a plurality of nodes, of the peer-to-peer network. In particular, a provision of an identifier and e.g. a status parameter data set can initiate the execution of said means. For instance, upon receipt of a message comprising the identifier from the first peer-to-peer module, a registering process may be initiated.

Preferably, prior to processing a message an authentication process can be conducted by e.g. an authentication means executable by at least a part of the nodes of the peer-to-peer application. The authentication process can comprise checking the sender of a message e.g. by checking a signature of the sender, and address of the sender, and/or the like.

The registering means is configured to register one or more recyclable material element(s). Registering is conducted by storing at least the provided identifier and the provided status parameter data set in a registry storage. In particular, each recyclable material element can be registered by storing at least the respective identifier and associated data, such as a current status of the respective recyclable material element.

The registry storage is updatable and, in particular, inspectable by at least a part of the participating entities/units of the system. Updatable means, in particular, that data associated with an identifier and the respective recyclable material element can be changed, deleted or added. Inspectable means, in particular, that other parties can read out data from the registry storage. Thereby, according to one embodiment, access to the data (preferably stored in encrypted form) can be controlled by the peer-to-peer application, in particular, an access controlling means of the peer-to-peer application.

The registry storage is at least controlled by the peer-to-peer application. For instance, the registry storage can be part of the peer-to-peer application. Alternatively or additionally, an (off-chain) storage arrangement comprising the at least one registry storage can be provided. The off-chain storage arrangement may be controlled by the peer-to-peer application. In particular, the access to data stored in the storage arrangement can be controlled by the peer-to-peer application. Preferably, the storage arrangement comprising a plurality of decentral storage units may be formed as a decentral file system (such as IPFS) or a decentral object store (such as storj) or a decentral distributed database (such as BigchainDB) controlled by the peer-to-peer application.

Preferably, further data can be stored in the registry storage and/or a further created storage (e.g. a digital product memory) linked to the respective identifier of a product in order to store data about a product comprising one or more recyclable material elements. The digital product memory (or the additionally stored data) may store any kind of data about the product, a list of (one or more) recyclable material element(s) or product component(s) and/or treatment parameter(s). It shall be understood that the treatment parameter(s) can also comprise instructions how to decompose a product into components/recyclable material elements that can be recycled individually, as will be explained hereinafter. Each of the product components might have its own identifier.

According to a first embodiment of the system of the present application, the tagging unit may comprise at least one tagging tool configured to attach at least one readable code element comprising the identifier to the recyclable material element. The code element may be an RFID (Radio-frequency identification) transponder (including a NFC (Near field communication) device), a 2D or 3D barcode, or the like. The code element comprises the identifier. In particular, the identifier can be read out by a reading tool, such as a RFID reader, NFC reader, barcode reader, etc.

In a preferred embodiment the identifier may comprise a crypto ID chip that can generate and hold a cryptographically secure ID and/or a set of public and private key(s). The crypto ID chip might be able to execute a set of cryptographically calculation(s), such as signing, hashing and/or encryption. A public key and/or an ID generated by the crypto ID chip might by registered in the peer-to-peer application and/or registry storage.

Attaching the code element can comprise incorporating the code element into the recyclable material element, mounting the code element onto recyclable material element at e.g. a wall of the recyclable material element and/or mounting the code element onto or incorporating the code element into a package of the recyclable material element. An identifier can be physically associated with a recyclable material element (or a container holding the element) and can be easily detected by recyclable material element processing unit(s) having suitable reading tool(s).

It is noted that providing an identifier to a recyclable material element can include writing an identifier into a code element already attached to the recyclable material element. It shall be understood that according to one embodiment two tagging units may be provided. A first tagging unit arranged for attaching a code element and a second tagging unit arranged for writing the identifier into the code element.

It shall be understood that a code element can be damaged or destroyed or can have a malfunction. In order to ensure resilience two or more code elements might be attached to a recyclable material element or a container holding said element. The two or more code elements might be linked to a unique identifier via a matching table stored in the peer-to-peer application. In an alternative embodiment two or more code elements may hold a similar identifier.

Furthermore, in order to detect at least one current status parameter of the recyclable material element, the tagging unit may comprise at least one (suitable) status detecting tool configured to detect at least one status parameter related to the recyclable material element. It shall be understood that a status, in particular a change of a status, can be also implicitly detected by another tool, such as a tagging tool.

As described above, preferably, the system comprises two or more recyclable material element processing units. According to one embodiment of the present system the system may further comprise at least one further recyclable material element processing unit. The recyclable material element processing unit may comprise at least one of a further status detecting tool and a reading tool configured to detect the identifier provided to the recyclable material element. At least one further peer-to-peer module may be assigned to the further recyclable material element processing unit and may be configured to provide at least the detected identifier and at least one further status parameter data set to the peer-to-peer application. Preferably, every recyclable material element processing unit comprises a peer-to-peer module for communicating with the peer-to-peer application, as described above.

Furthermore, according to one embodiment, the peer-to-peer application may be configured to receive at least one treatment parameter data set related to the recyclable material element. For instance, respective data can be received by a peer-to-peer module of e.g. a production unit of the recyclable material element. Alternatively or additionally, so called data feeds can be provided by the peer-to-peer application (so called “smart oracles”). Data feeds can provide further treatment parameter data relating to a treatment/process of the recyclable material element, e.g. during a recycling step, from at least one further source. Data can be captured from trusted sources off-chain and stored on the block chain or stored via the peer-to-peer application on a decentral data storage entity. A treatment parameter relates to a specific treatment of the recyclable material element, in particular, during a recycling step. During a recycling step, a recycling process of converting an used recyclable material element (waste material) into reusable recyclable material element to prevent waste of potentially useful materials, reduce the consumption of fresh raw materials, energy usage, air pollution (from incineration) and water pollution (from landfilling) by decreasing the need for “conventional” waste disposal and lowering greenhouse gas emissions compared to plastic production. Examples of treatment parameter(s) include information about the composition/ingredients (e.g. in percent by weight per ingredient) of the recyclable material element, instruction(s) or rule(s) for treatment/processing a recyclable material element during a recycling step, etc. The correct execution of treatment parameter(s) and/or the output can be tracked and e.g. stored in the peer-to-peer application (or other storage).

The registering means may be further configured to store at least one treatment parameter data set related to the recyclable material element together with the identifier of the recyclable material element in the registry storage. Since the registry storage can be inspected each interested entity can receive (e.g. based on the identifier of the recyclable material element) a desired treatment parameter data set e.g. in order to treat/process said recyclable material element.

According to a preferred embodiment of the system according to the present application, the system may comprise at least one further recyclable material element processing unit in form of a recycling unit. The recycling unit may comprise at least one recycling tool configured to process a provided recyclable material element during at least one recycling step. A further peer-to-peer module assigned to the recycling unit may be at least configured to receive the stored treatment parameter data set related to the recyclable material element (to be processed) from the peer-to-peer application. At least the recycling tool may be configured to process the recyclable material element at least based on the received treatment parameter data set. The recycling unit may comprise one or more recycling tool(s). A recycling tool may be configured to conduct at least a sub-process of the total recycling process of an used recyclable material element. Examples of such tools are heating tools, cooling tools, cleaning tools, mechanical decomposition tools, chemical decomposition tools, biological process tools, sorting tools, etc. In order to optimize the operation of a recycling unit, at least one of the recycling tool(s) of the recycling unit can be operated/controlled based on at least one treatment parameter of a treatment parameter data set. For instance, based on a detected identifier of a (used) recyclable material element the corresponding treatment parameter data set can be received from the peer-to-peer application. For instance, based on a request message comprising the detected identifier, the peer-to-peer application may send a response comprising the respective treatment parameter data set. The recycling unit may be configured to analyze the received treatment parameter data set in order to provide each of the recycling tool(s) of the recycling unit with the respective one or more treatment parameter(s).

In a further embodiment of the present system, the system comprises at least one further recyclable material element processing unit in form of a delivery unit. The at least one delivery unit may comprise at least one dispensing tool configured to dispense at least one recyclable material element to at least one recipient. The delivery unit may comprise at least one recipient identifier detecting unit configured to detect at least one recipient identifier assigned to the recipient of the dispensed recyclable material element. A further peer-to-peer module assigned to the delivery unit may be at least configured to provide the recipient identifier and the identifier of the dispensed recyclable material element to the peer-to-peer application. Preferably, the delivery unit can be configured to detect each dispensed recyclable material element e.g. by using a previously described reading tool (e.g. integrated in the dispensing tool). In addition, an identifier assigned to a recipient, such as an user or machine, can be detected. For instance, a further code element of the recipient can be read out. Also a manual input is possible. The identifier can be associated to the identifier of the dispensed recyclable material element. The registry storage can be updated accordingly. More particular, upon receipt e.g. of a message comprising the identifier of the dispensed recyclable material element and the recipient identifier the execution of the registering means (or a further means) by a part of the nodes of the peer-to-peer network can be initiated. The registering means may be configured to store the received recipient identifier together with the identifier of the dispensed recyclable material element in the inspectable registry storage. The recipient may be an entity registered in the peer-to-peer application.

What is more, according to an embodiment, the peer-to-peer application may be configured to generate a delivery transaction agreement about the delivery and/or return of a (dispensed) recyclable material element between a providing entity and the recipient at least based on the recipient identifier. Preferably, the receipt of an information about the dispensing of one or more specific recyclable material element(s) and the recipient identifier may automatically cause generation of a delivery transaction agreement. In the delivery transaction agreement details about the delivery of a (unused) recyclable material element and/or return of a (used) recyclable material element can be defined and stored. The delivery transaction agreement e.g. in form of a smart contract may be stored in the peer-to-peer application.

According to a preferred embodiment, the generated delivery transaction agreement may comprise at least the recipient identifier, the identifier of the recyclable material element and at least one delivery transaction criterion. In particular, a plurality of delivery/return transaction criterions can be defined and stored. For instance, a first delivery/return transaction criterion may be at least one status requirement which must be met by returning the recyclable material element. For instance, the recyclable material element must be returned (essentially) undamaged. A further delivery/return transaction criterion may be a financially value to be paid by the recipient for the use of the recyclable material element. Use may include the consumption of a content of the recyclable material element. A further delivery/return transaction criterion may be a deposit for using the recyclable material element. The deposit may be returned after return of the (used) recyclable material element. It may be possible that the deposit is only returned if the returned recyclable material element meets the defined status requirement. Additional data, which can be stored in a delivery transaction agreement, can include time of dispense, time at until which the recyclable material element has to be returned, provider identifier, etc.

Financial values can be (instantaneously) exchanged with a transaction via a cryptocurrency. Escrow functionality can be used to mitigate credit risk of transactions. In an embodiment, micropayment channels may be used for a (constant) payment stream that can be handled e.g. partly off-chain to reduce the amount of on-chain transactions. In a further embodiment so called state channels or state networks (e.g. Raiden Network, Lightning Network) may be used to exchange digital tokens off-chain in a secure way. Opening and/or closing of state channels may be registered on the peer-to-peer application. This means that individual transactions may not be stored on the peer-to-peer application in order to improve scalability and avoid movement tracking of pseudonyms on the peer-to-peer application. In an embodiment, advanced cryptographic methods may be used to enable anonymous transactions (e.g. zk Proof Systems, Ring Signatures, Mixers, HD Wallets). According to the present application, a man-in-the-middle is not necessary. Fully automated processes from authentication to delivering, returning and accounting can be provided.

In a further embodiment of the present system, the system comprises at least one further recyclable material element processing unit in form of a return unit. The at least one return unit may comprise at least one receiving tool configured to receive at least one recyclable material element. A further peer-to-peer module assigned to the return unit may be at least configured to provide the identifier of the returned recyclable material element to the peer-to-peer application. A return unit may be part of a return entity. In a preferred embodiment, the return unit can be a smart bin or an automated return machine. In particular, by means of a reading tool, an identifier of a returned (and used) recyclable material element can be detected. The peer-to-peer module of the return unit is configured to provide the information about the return of a specific recyclable material element to the peer-to-peer application.

Preferably, the return unit may comprise one or more status detecting tool(s) each configured to detect at least one status parameter related to a returned recyclable material element. For instance, a condition (damaged, undamaged, dirty, weight differences, composition changes, etc.) of the recyclable material element can be detected. The peer-to-peer module of the return unit may be (also) configured to provide a (current) status parameter data set to the peer-to-peer application.

According to a preferred embodiment of the present application, the peer-to-peer application may comprise at least one accounting means. The accounting means may be executable upon provision of the provided identifier of the returned recyclable material element. The accounting means may be at least configured to conduct an accounting process based on the provided identifier of the returned recyclable material element and at least one delivery/return transaction criterion stored in the delivery transaction agreement. Preferably, the receipt of a message comprising an identifier of a recyclable material element and the information that said recyclable material element has been returned the accounting means can be executed. The accounting means may be a part of the respective delivery transaction agreement. Based on the identifier of the returned recyclable material element the corresponding at least one delivery/return transaction criterion, such as a stored deposit, can be identified. The deposit can be e.g. retransferred to the recipient, as previously described. In one embodiment, a further delivery/return transaction criterion in form of a status requirement (data set) to be met by a returned recyclable material element can be checked. Preferably, the accounting means may only return the deposit if said status requirement (data set) is actually met. For instance, a status parameter data set related to the returned recyclable material element and received from the return unit can be compared with the status requirement (data set) stored in the delivery transaction agreement in order to check the fulfillment (or not fulfillment) of the stored status requirement (data set).

In a further embodiment, further accounting process(es) can be conducted by means of the accounting means (or another means) based on e.g. a further delivery/return transaction criterion stored in the delivery transaction agreement. For instance, after dispensing a recyclable material element, an accounting process can be conducted.

In a further embodiment of the present application, the peer-to-peer application may comprise at least one analysis means. The analysis means may be executable upon an analysis request message. The analysis means may comprise one or more algorithm(s) for processing data stored in the peer-to-peer application. Data processing can be done for different purposes, for instance reporting purposes (e.g. reports to authorities about proper handling of materials in accordance to regulatory requirements), optimization purposes (e.g. to improve the whole material life cycle efficiency or resource usage) or for analytical purposes (e.g. to generate statistics about material life cycle or an analysis where raw materials are in the life cycle, where are the located, how they can be extracted or accessed and how and where they can be reused).

According to a further embodiment of the present application, the peer-to-peer application may further comprise adapting means for adapting a reputation factor of at least one entity (unit, recipient, etc.) at least based on the verification result. A reputation factor according to the present application is an indication about the reliability of an entity, in particular, regarding its functioning, payment behavior, return of undamaged recyclable material elements, etc. While e.g. a recipient which pays for recyclable material elements properly (e.g. according to predefined requirements) and returns recyclable material elements properly (e.g. according to predefined requirements) may have a higher reputation factor (e.g. a higher value) than a recipient which does not (always) meets these requirements. Further parameters can be taken into account for rating an entity, such as the prompt (or delayed) execution of an offer, a correct transaction of an offer, etc. Each unit can be individually rated in the system. Prices and/or deposits can be calculated in accordance to reputation factors of a unit.

In order to set-up a raw material and/or recycling system, it is preferred that each recyclable material element processing unit is previously registered in the peer-to-peer application. According to a further embodiment of the system according to the present application, the peer-to-peer application may comprise at least one further registration means configured to receive a registering message of a peer-to-peer module assigned to at least one recyclable material element processing unit. The registration means may be configured to register the recyclable material element processing unit by storing a unique identifier of the recyclable material element processing unit in the peer-to-peer application and/or a storage arrangement controlled by the peer-to-peer application.

The registration means of the peer-to-peer application may be configured to receive a registering message of a peer-to-peer module assigned to a recyclable material element processing unit. The registration means may be configured to register the recyclable material element processing unit by storing a unique (peer-to-peer) identifier. The identifier can be stored in an identifier list of the peer-to-peer application. Preferably, the identifier list can be stored in the peer-to-peer application and/or a storage arrangement controlled by the peer-to-peer application. The identifier list can be used for authorization processes e.g. prior to allowing the generation of an delivery transaction agreement or the like. For instance, in order to validate a sender of a message, each message can be provided with a signature of the sender. The signature can be checked by the peer-to-peer application by using the identifier list. For instance, only in the case the signature of the message corresponds to an identifier/signature stored in the identifier list, the message can be validated.

More particularly, a recyclable material element processing unit, recipient or the like can be registered in the peer-to-peer application, as e.g. a so called smart asset. Each registered unit/recipient/entity can be stored with its unique (peer-to-peer) identifier e.g. in one or more identifier list(s) of authorized entities. An identifier of an unit/recipient/entity might be already a peer-to-peer identifier or another identifier suitable to uniquely identify the unit/recipient/entity. The unique peer-to-peer identifier may be a serial number or a smart asset hash of e.g. the entity, the user's name of the entity, a communication address of an entity, a signature, etc. If e.g. an identifier of an entity is not already a unique peer-to-peer identifier, e.g. if the identifier is non-unique name of a user, the peer-to-peer application, in particular, the registering means, may be configured to generate a unique peer-to-peer identifier for the respective entity (according to preset rule(s)). Preferably the identifier is generated by crypto ID chip.

It shall be understood that an entity can be a user registered in the peer-to-peer application. Each registered user can be stored with or linked to its unique (peer-to-peer identifier) e.g. in one or more identifier list(s) of authorized entities. According to an embodiment of the system according to the present application, a user may authenticate himself at one of the peer-to-peer modules of the system.

Prior to the registration of an unit/recipient/entity (e.g. recyclable material element processing unit), at least part of the nodes (peers) of the peer-to-peer network may check, in particular, by executing the registration means, whether the registering requirements (such as specific entity specifications or valid signatures or compliance requirements) predefined by the peer-to-peer network are met by the unit/recipient/entity requesting registration. For instance, it may be necessary that a recyclable material element processing unit meets predefined technical specifications. In order to perform the check, preferably, further data may be included in the registering message. In particular, the peers of the peer-to-peer network may provide registering rules or registering requirements which must be fulfilled by an unit/recipient/entity to be regarded as a trustful entity. Rules/requirements may be individually defined by the peers of a peer-to-peer network. E.g. it may be necessary that a new unit/recipient/entity must be recommended by an entity which is already a participant of the peer-to-peer network. In addition, it may be necessary that this participant must have a reputation factor which increases a predefined minimum reputation factor. For instance, if a recyclable material element processing unit has a low reputation factor, the recyclable material element processing unit may not be registered by the registration means. Further data may be technical data regarding the performance of a recyclable material element processing unit and/or the location (e.g. GPS coordinates) of a recyclable material element processing unit. Only if the requesting unit/recipient/entity fulfills the technical requirements and/or location requirements of the peer-to-peer network, the requesting entity may be registered in the peer-to-peer application.

According to a further preferred embodiment, the at least one peer-to-peer application can be a decentralized register, distributed ledger or a shared database configured to store data, e.g. identifiers, delivery transaction agreement(s), access transaction agreements, data set(s), etc., with given certain proofs or signatures. In addition to e.g. identifiers, the decentral register can store computer code in form of executable means. In particular, an executable means can be invoked by a transaction to the (unique) communication address of the executable means in so called ‘smart contracts’. This executable means can be processed on the plurality of node(s) of the peer-to-peer network.

It shall be understood that executable means (e.g. smart contracts) or processing logic might be stored and executed in so called ‘crypto conditions’ of the Interledger protocol (ILP). This means that not necessarily all code of an executable means must be stored in a smart contract such as Ethereum smart contract.

In a further embodiment, the executable means (smart contract) might be stored and executed on a decentral computation market (e.g. Ethereum Computation Market, Trubit, Golem, Cryplets Microsoft).

In a further embodiment, executable means of an external computing device controlled by the peer-to-peer application may include algorithm(s) for de-central cognitive analytics, artificial intelligence or machine learning. Analytics and learning can be shared with other entities, aggregated and further analyzed via the peer-to-peer application(s).

A decentralized register can be readable at least by a part of the participating entities (participants) of the peer-to-peer network. In particular, every computer node can comprise the peer-to-peer application. The decentralized register, at least the public part (i.e. may be without private contracts) may be read at least by each participant of the peer-to-peer network. In particular, all peer-to-peer modules and all other nodes of the peer-to-peer network can preferably read all information in the peer-to-peer application formed as a register. Preference is also that all peer-to-peer modules and all other computers of the peer-to-peer network can send messages to or write messages to the peer-to-peer application. A message or transaction sent to an executable means, such as a registering means, an accounting means, etc., may start the execution of a code of the executable means while using data (transaction criterions and/or other data) stored in the executable means. For instance, sending an identifier of a newly tagged recyclable material element to a registering means may start the execution of the code resulting in e.g. conducting a registering process, as described hereinbefore.

The peer-to-peer application might be built upon the following elements: peer-to-peer network comprising Consensus System/Protocol, Data Structure, Merkle Trees, Public Key Signatures and/or Byzantine Fault Tolerance. It may replicate data based on a consensus principle. It may be auditable and traceable.

In a simple way, information can be made available to preferably all participants. This may allow to carry out a review of the information stored in the decentral register or the code and means, respectively, executed in the decentral register. Particularly preferably, each computer (node) in the peer-to-peer network can be configured to review new information, in particular, based on older information stored in the peer-to-peer application. In addition, the registering means, the accounting means, and the like may be monitored by at least a part of the nodes of the peer-to-peer network, preferably by all nodes. A manipulation of an implemented executable code can thus be prevented, at least detected.

Moreover, at least a plurality of nodes, preferably each node can in each case comprise the complete data content, but include at least a portion of the data contents of the peer-to-peer application, in particular, of the decentral register. For example, it may be provided that after a positive verification of written information or e.g. a positive registration in the peer-to-peer application this information is saved by all nodes, at least by a part of the nodes. For instance, after the generation of a delivery transaction agreement and/or after a successful registration, the agreement and (new) identifier, respectively, can be stored at least by a part, preferably all nodes of the peer-to-peer network (and/or in a data storage controlled by the peer-to-peer application). The tamper resistance of the data stored in the peer-to-peer application can thereby be further improved. A registering process or accounting process can be securely controlled.

In order to store new information in a tamper-proof way, the peer-to-peer application can comprise encryption means and/or signature means and/or verifying means, wherein at least one of the encryption means and/or signature means and/or verifying means is configured to store data, such as parameter data set(s), identifier(s), delivery transaction agreement (s), etc. In particular, encryption means and/or signature means and/or verifying means can be combined with a previously described registering means. In particular, it can be provided that by the hash function a link is established with at least one previously stored information in the decentral register. Further data, such as request messages, ordinary, contextual and/or transaction data of an entity, such as a provider entity, recipient entity, can be stored.

The peer-to-peer application may be formed by a Directed Acyclic Graph (DAG). A directed acyclic graph, such as IOTA or Tangle, means that blocks (or nodes of the graph) are coupled to each other via directed edges. Thereby, direct means that the (all) edges have (always) a same direction similar to time. In other words, it is not possible to step back. Eventually, acyclic means that loops do not exist.

In a particularly preferred embodiment of the present system, the peer-to-peer application can be a block chain or decentral ledger comprising at least two blocks coupled to each other (e.g. Ethereum Block chain with Smart Contracts). The block chain technology or “decentral ledger technology” is already used in the payment by means of a crypto currency, such as Bitcoin.

In addition, the block chain can be used to control and manage a raw material and/or recycling system. The block chain can be, in particular, used to execute predefinable process(es), e.g. registering process(es) or the like, caused by at least one peer-to-peer module and/or a previously described executable means in a tamper-proof manner. The block chain according to the present embodiment is, particularly, a decentralized, peer-to-peer-based register in which all data related to at least one recyclable material element can be logged. A block chain is particularly suitable as a technical means to replace a central entity/server in a simple and secure manner.

In further embodiments of the peer-to-peer application, the block chain can be a permissionless or permissioned block chain. In a specific case, the block chain can be public, consortium or private block chain.

In a further embodiment, the peer-to-peer application can be formed by multiple block chains which are connected via mechanisms, such as side chains or smart contracts. A peer-to-peer node can run one or more different block chain client (s).

Data of the peer-to-peer application can be stored on the “decentral ledger technology” and/or the decentral ledger steers (encrypted) data storage accessible via the internet and preferably in de-central data storage, object store and database, respectively, such as Interplanetary File System (IPFS) or storj or in a distributed Blockchain database (e.g. BigChainDB). Access to encrypted data to third party entities is managed via an access means formed as one or more smart contract(s) on the block chain.

In addition, data feeds can be provided by the peer-to-peer application (so called “smart oracles”). Data feeds can provide further data (e.g. ingredients and the portion in the recyclable material element) relating to a recyclable material element from at least one further source. Data can be captured from trusted sources off-chain and stored on the block chain or stored via the block chain on a decentral data storage entity.

Information among peer-nodes can be exchanged by a peer-to-peer messaging system. This means a peer node can send a message to another peer node to submit an information or to trigger an action. Messages can be clear text, signed, hashed, time-stamped and/or encrypted. This means that not all data exchanged among peer nodes must be stored on the block chain.

In a further embodiment, the at least one peer-to-peer network can be formed by a plurality of (computer) nodes of a peer-to-peer network and peer-to-peer module(s), such as a peer-to-peer module of a tagging unit, a peer-to-peer module of a delivery unit, a peer-to-peer module of a return unit, etc. A peer-to-peer module may be only configured to communicate with the plurality of computer nodes. In other words, the peer-to-peer module is not a computer node of the peer-to-peer network but only a participant or participating entity. Such a peer-to-peer module does not comprise the peer-to-peer application but only provides an interface module, such as an application programming interface (API), and a decentral application for communication with the computer nodes of the peer-to-peer network or the peer-to-peer application, such as a block chain or a smart contract on the block chain. For instance, such a peer-to-peer module can either send clear text or encrypted information or generate a secure connection (e.g. tunnel) to a peer-to-peer gateway (or so called “remote node”) in order to communicate with the peer-to-peer network. This allows reducing the required processing power of the peer-to-peer module.

In one implementation of the peer-to-peer network, there can be only one validating peer or full node, e.g. only one node can be configured to perform a validation process, e.g. conducting a registering process, and one or more observing (or monitoring) nodes. An observing node can validate transactions to establish a trust level but does not validate all transactions which is done by the validating peer.

In a further embodiment, the peer-to-peer module is one of the nodes. In this case, the peer-to-peer module comprises at least a part of the peer-to-peer application. In particular, the peer-to-peer module can comprise preferably the total data content of the peer-to-peer application or can access the information stored in another node. For instance, the peer-to-peer module might be a so called “light node” or a decentral application (DAPP) connected to a remote node.

It is noted that in the present case, according to an embodiment, the peer-to-peer module comprises at least an API configured to communicate with the peer-to-peer application, such as the block chain. In addition to the API, the peer-to-peer module comprises a decentral application of software comprising local algorithms at least configured to create and transmit data, such as status parameter data set(s), identifiers, treatment parameter data set(s), to the peer-to-peer application via the API. The decentral application so called “Dapp” is at least configured to process and transmit said data.

Preferably, data and messages are signed or encrypted or can be transmitted via a cryptographically secured tunnel or a secured internet connection to a peer-to-peer node running the peer-to-peer application, such as the block chain. In another particular embodiment, also the peer-to-peer application itself is implemented in the peer-to-peer module, i.e. the peer-to-peer module is a node of the peer-to-peer network comprising the decentral application, the API and the peer-to-peer application, such as the block chain or decentral ledger.

Data and transactions stored on the block chain do not provide “transactional privacy”. Transactions between pseudonyms may be (often) stored in clear text on the block chain. In some cases, data stored on the block chain are encrypted and the keys may be handled via the block chain. Transactions between pseudonyms are stored in clear text on the block chain. Privacy preserving, secure transactions or execution of computer code can be achieved with cryptographic tools, such as zero knowledge (zk) proofs or zk Succinct Non-interactive Arguments (zk-SNARK). Transactions or algorithms are separated into two parts: an executable means (e.g. a smart contract) on the block chain and a further executable means (e.g. a private contract). A privacy preserving protocol ensures the privacy of data and the correctness of code execution (SNARK verification is done via the smart contract on chain). The private contract computation can be done by a set of nodes, off-chain computers or done in measured launch environment or a secure hardware enclave for attestation and sealing that cannot be manipulated by other software code running on the devices. In an alternative embodiment, secure Multi-Party-Computing (sMPC) systems can be used for transactional privacy. Examples for privacy preserving protocols and computation are HAWK and MIT Enigma.

With zero knowledge proof (zk Proofs) the parties can see that the algorithm is executed correctly in a private contract, but the input data are not disclosed to the party. zk Proofs may be stored in and/or validated by the peer-to-peer application. In addition, selective privacy can be achieved by sharing keys to decrypt transactions for reporting and auditing purposes.

To securely deploy an executable means and or data into a device a trusted execution environment, such as Intel SGX or TPM or Direct Anonymous Attestation module, can be integrated with a peer-to-peer module.

Similarly, in a further embodiment, a particularly large peer-to-peer network may be divided in two or more (physical or logical or dynamically virtual) cluster(s). In a corresponding peer-to-peer network, for example, a validation (of a subset of transactions) may only be carried out by the members of one cluster (a subset of nodes; e.g. sharding of a block chain to improve the scalability). In a further embodiment, the peer-to-peer application can be formed using multiple block chains. These block chains are connected via frameworks such as sidechains or smart contracts or interledger protocol.

A further aspect of the present invention is a recyclable material element processing unit for a raw material and/or recycling system, in particular, previously described raw material and/or recycling system. The recyclable material element processing comprises at least one status detecting tool configured to detect at least one status parameter related to at least one recyclable material element. The recyclable material element processing comprises at least one reading tool configured to detect an identifier provided to the recyclable material element. The recyclable material element processing comprises at least one peer-to-peer module configured to provide at least the detected identifier and at least one status parameter data set comprising at least the detected status parameter to at least one peer-to-peer application of at least one peer-to-peer network such that the identifier and the status parameter data set are stored in at least one registry storage by at least one registering means of the peer-to-peer application.

Preferably, the at least one recyclable material element processing may be a previously described tagging unit, a previously described recycling unit, a previously described delivery unit and/or a previously described return unit. It shall be understood that at least two of the previously described units can be combined to a common unit, such as a delivery and return unit or tagging a delivery unit or the like.

A further aspect of the present application is a method for operating a raw material and/or recycling system, in particular, a previously described raw material and/or recycling system. The method comprises:
providing at least one recyclable material element,
providing at least one identifier to the provided recyclable material element, and
registering the recyclable material element (in the raw material and/or recycling system) by storing at least the provided identifier and the provided status parameter data set in at least one registry storage by means of at least one registering means of at least one peer-to-peer application of at least one peer-to-peer network,
wherein the registering means is executed upon provision of the provided identifier by at least a part of the nodes of the peer-to-peer network.

A still further aspect of the present application is a peer-to-peer application of at least one peer-to-peer network. The peer-to-peer application comprises at least one registering means configured to register at least one recyclable material element by storing at least one received identifier of the recyclable material element and at least one received status parameter data set related to the recyclable material element in at least one registry storage controlled by the peer-to-peer application.

The peer-to-peer application can be used in a previously described raw material and/or recycling system.

Generally, a module or means can be formed by software and/or hardware. An unit can comprise hardware (processor, memory, etc.) and/or software (operating system, etc.).

The features of the methods, systems, modules, peer-to-peer applications, units, and computer programs can be freely combined with one another. In particular, features of the description and/or the dependent claims, even when the features of the dependent claims are completely or partially avoided, may be independently inventive in isolation or freely combinable with one another.

These and other aspects of the present patent application become apparent from and will be elucidated with reference to the following figures. The features of the present application and of its exemplary embodiments as presented above are understood to be disclosed also in all possible combinations with each other.

### BRIEF DESCRIPTION OF THE DRAWING

In the figures:

FIG. 1 shows a schematic view of an embodiment of a raw material and/or recycling system according to prior art;

FIG. 2 shows a schematic view of a further embodiment of a raw material and/or recycling system according to the present application;

FIG. 3 shows a schematic view of a further embodiment of a raw material and/or recycling system according to the present application;

FIG. 4 shows a schematic view of an embodiment of a peer-to-peer application 424 according to the present application;

FIG. 5 shows a schematic view of a further embodiment of a raw material and/or recycling system according to the present application;

FIG. 6 shows a diagram of an embodiment of a method according to the present application; and

FIG. 7 shows a diagram of a further embodiment of a method according to the present application.

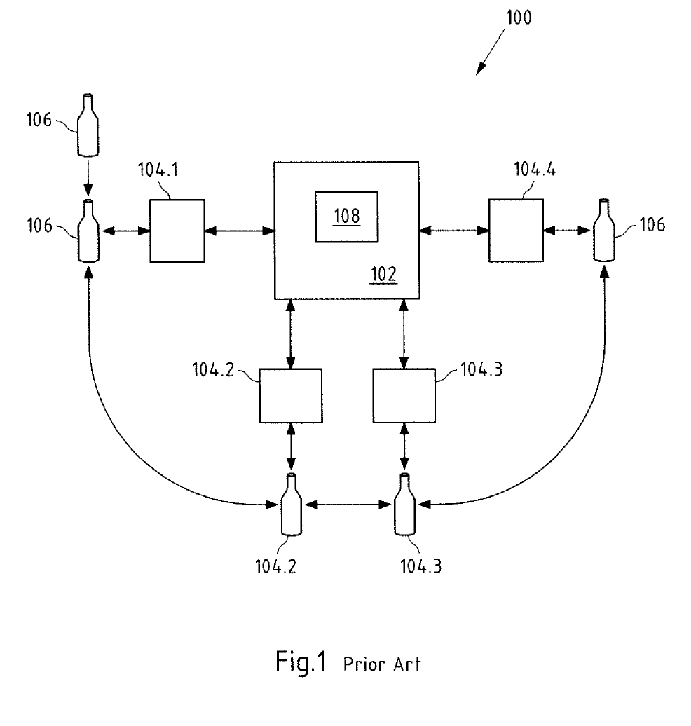

### DETAILED DESCRIPTION

Like reference numerals in different figures indicate like elements.

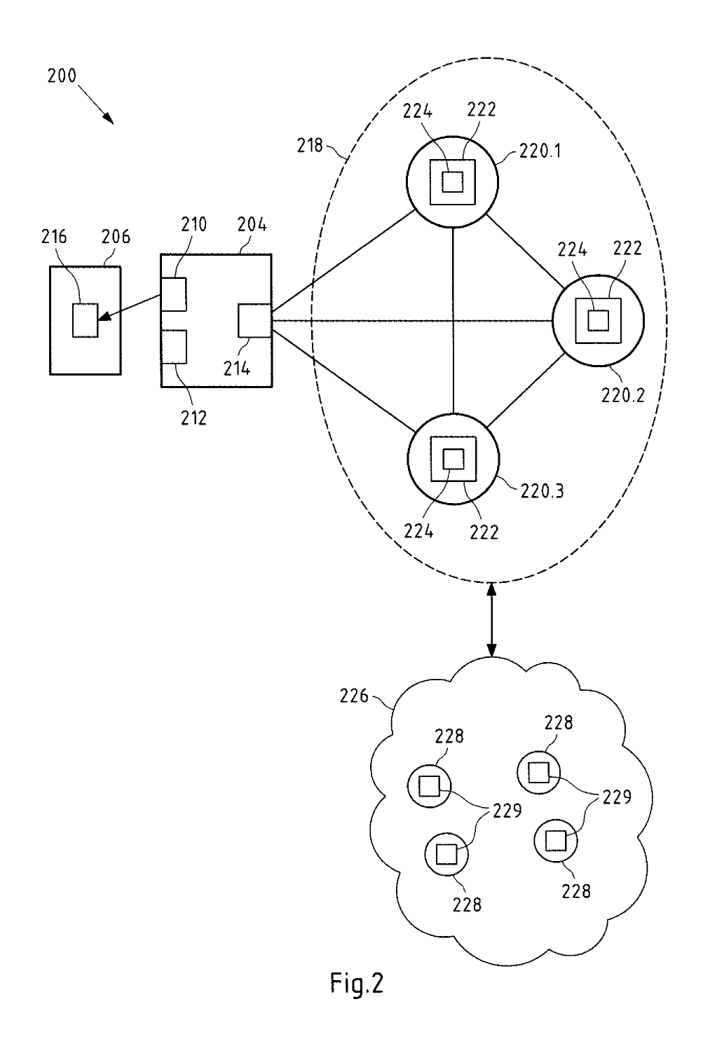

FIG. 2 shows a schematic view of an embodiment of a raw material and/or recycling system 200 according to the present application. The system 200 comprises at least one recyclable material element processing unit 204 in form of a tagging unit 204. The tagging unit 204 is configured to provide a (unique) identifier to a recyclable material element 206. In particular, as can be seen from FIG. 2, the tagging unit 204 comprises a tagging tool 210 configured to attach a code element 216, such as an RFID transponder tag 216, a NFC transponder tag 216, a QR code 216, or a barcode 216, to a recyclable material element 206. The code element 216 can be read out by a reading tool of e.g. a further recyclable material element processing unit. For instance, if the identifier is stored in a memory of a code element 216 in form of a (passive) RFID transponder 216, the identifier can be read out by a RFID reader. The identifier may be also stored the peer-to-peer application or a further storage arrangement 226.

Furthermore, preferably the recyclable material element processing unit 204 comprises a status detecting tool 212 configured to detect at least one status parameter related to the (tagged) recyclable material element 206. For instance, the status detecting tool 212 can detect the successful attachment of a code element 216 to the recyclable material element 206. This detection may result in a changed status or condition of the recyclable material element, e.g. ‘new’, ‘damaged’, ‘changed’ or ‘unused’.

Further status parameter(s) can be detected and/or stored in the peer-to-peer application 222 (or a further storage 226). Examples of status parameters are the (current) location of the code element 216, a time stamp, an identifier of the tagging unit 204, etc. For instance, the tagging unit 204 may be a stationary unit arranged at a known location (e.g. an address, geographic coordinates (e.g. GPS coordinates)). Then, as a location parameter the identifier of the tagging unit 204 (and a look-up table e.g. stored in the peer-to-peer application) may be sufficient to detect a location parameter. Alternatively or additionally, a tagging unit 204 may comprise a location sensor (e.g. GPS sensor). In particular, a mobile recyclable material element processing unit can be provided with such a sensor.

Preferably, one or more of these status parameters can be combined in a status parameter data set related to said recyclable material element 206.

It shall be understood that generally a status detecting tool may be a separate module or may be (implicitly) incorporated in another tool, such as a tagging tool. For instance, after a code element is successfully attached to a recyclable material element the status of the recyclable material element, e.g. ‘new’ and/or ‘unused’, is (implicitly) detected by the tool, such as the tagging tool.

Preferably, at least a current status parameter data set can be additionally stored in the code element 216. For instance, the tagging tool 210 can be configured to store the respective data set into the code element 216. The code element 216 may be updatable. In other words, in each case a status change is detected, the respective current status parameter data set can be provided to the peer-to-peer application and, preferably, stored in the code element 216.

It shall be understood that the status parameters can be stored in the peer-to-peer application 222 (or a further storage 226). A status parameter release transaction agreement can be generated upon successful storage of status parameter(s) in the peer-to-peer application 222 (or a further storage 226) that was read out of a code element 216. For instance, the tagging tool 210 can be configured to control a data storage release process in the code element 216 upon receiving the status parameter release transaction agreement from the peer-to-peer application 222. This approach may ensure that the limited data storage size in a code element is used effectively.

Further, the system 200 comprises a peer-to-peer network 218. According to the depicted preferred embodiment of the present application, no central instance and/or third party organization is provided. In the present case, the system 200 comprises a so called peer-to-peer network 218 or a computer-computer network 218. The peer-to-peer network 218 comprises a plurality of nodes 220.1, 220.2, 220.3 (only three nodes are depicted for sake of clarity) and computers 220.1, 220.2, 220.3, respectively. A peer-to-peer network 218 is characterized in the present case in that each node 220.1, 220.2, 220.3 and/or participant 214 is preferably connectable at least to every other node 220.1, 220.2, 220.3 and/or participant 214. For instance, at least one physical standard network (wired and/or wireless) can be used for connection. For communicating via the at least one physical standard network suitable transceiver modules may be arranged in the respective entities/devices.

In addition, the computers 220.1, 220.2, 220.3 have equal rights, something which distinguishes them from a server-client structure.

The depicted nodes 220.1, 220.2, 220.3 (each) comprise a peer-to-peer application 222. As can be seen from FIG. 2, the same peer-to-peer application 222 is preferably implemented on each node 220.1, 220.2, 220.3. This means, in particular, that the same content is comprised on each node 220.1, 220.2, 220.3 and that the same code (including one or more executable means 224) can be executed on each node 220.1, 220.2, 220.3.

The peer-to-peer application 222 may preferably be a public register 222 that can, in particular, be inspected by all participants 220.1, 220.2, 220.3, 214 (not only the nodes 220.1, 220.2, 220.3) of the peer-to-peer network 218. Each of the 220.1, 220.2, 220.3 preferably has the (entire) public register 222. It may also be envisaged that only part of the register can be provided on a node (light node). In a particularly preferred embodiment, the peer-to-peer application 222 may be a block chain 222, which will be explained in more details hereinafter. It shall be understood that a peer-to-peer network may comprise further nodes. In addition, it shall be understood that also a recyclable material element processing unit can be formed as or comprise a node of the peer-to-peer network.

The peer-to-peer application 222 comprises a registering means 224, in particular, in form of a smart contract 224. The registering means 224 is configured to register one or more recyclable material element(s) 206 in the peer-to-peer application 222. In particular, the registering means 224 is configured to store the identifier of a recyclable material element 206 and a status parameter data set related to said recyclable material element 206. It shall be understood that a plurality of recyclable material elements 206 can be registered, as will be described hereinafter.

The peer-to-peer application 224 may be configured to manage and control the raw material and/or recycling system 200.

Further, a first peer-to-peer module 214 assigned to the recyclable material element processing unit 204 in form of a tagging unit 204 is provided. In the present example, the first peer-to-peer module 214 is integrated in the tagging unit 204, e.g. within a computing element of the tagging unit 204.

A peer-to-peer module 214 is (generally) configured to communicate at least with the peer-to-peer network 218, i.e. the nodes 220.1, 220.2, 220.3 of the peer-to-peer network 218. In other words, the first peer-to-peer module 214 or the tagging unit 204 corresponding or assigned to the respective peer-to-peer module 214 is at least a participant of the peer-to-peer network 218. Preferably, all participants 220.1, 220.2, 220.3, 214 (including all nodes) of the peer-to-peer network 218 are known to each participant 220.1, 220.2, 220.3, 214 of the peer-to-peer network 218.

In the present case, all peer-to-peer modules 214 are not nodes of the peer-to-peer network 218 but only a participant 214. While nodes 220.1, 220.2, 220.3 in the peer-to-peer network 218 comprise at least a part of the peer-to-peer application 222 itself, a participant of a peer-to-peer network 218, like the present peer-to-peer module 214, does not comprise the peer-to-peer application 222. Such a peer-to-peer module 214 is configured to provide (only) access to the peer-to-peer application 222 e.g. via an API (application programming interface). Each peer-to-peer module 214 (also a node or light node) may comprise a decentral application and at least an API.

In the case the peer-to-peer module is formed as a node of the peer-to-peer network the peer-to-peer module (also) comprises at least partly the peer-to-peer application. It shall be understood that a peer-to-peer module might be a node of the peer-to-peer network. It shall be understood that a peer-to-peer module may have access or may be connected to a “gateway” running a node of the peer-to-peer network (so called remote node).

The tagging tool 210 and/or the status detecting tool 212 may have a (internal) communication connection to the peer-to-peer module 214. For instance, after a code element 216 comprising an (unique) identifier is attached to the recyclable material element 206 and e.g. after one or more status parameter related to said recyclable material element 206 are detected, the identifier and/or e.g. one status parameter data set can be forwarded to the peer-to-peer module 214. The peer-to-peer module 214 is configured to provide the identifier and the status parameter data set related to the recyclable material element 206 to the peer-to-peer application 222 e.g. by sending one or more messages to the peer-to-peer application 222.

The reception of such a message may automatically cause the execution of the registering means 224 by a part (e.g. all nodes) 220.1, 220.2, 220.3 of the nodes 220.1, 220.2, 220.3.

Preferably, each message can be provided with a signature or the like. Prior to processing a message, a message can be validated by checking the signature of the message e.g. by comparing the signature with valid signatures stored e.g. in the peer-to-peer application. Preferably, a part 220.1, 220.2, 220.3 of the nodes 220.1, 220.2, 220.3 can conduct the validation process. Only in case of a positive result, e.g. in case of a match between the received signature and the stored signatures, a message may be further processed. It shall be understood that other means than signatures (e.g. communication addresses, certificates, etc.) can be used for a validation process or authentication process, respectively.

For instance, upon a positive authentication process, the registering means 224 is executed such that the received identifier and the status parameter data set is stored in a registry storage 229 in order to register the recyclable material element 206 in the system 200.

In the present case, an off-chain storage arrangement 226 comprises the registry storage 229. The off-chain storage arrangement 226 is controlled by the peer-to-peer application 222. In particular, the access to data stored in the storage arrangement 226 can be controlled/permitted by the peer-to-peer application 222 e.g. depending on access transaction agreement(s).

Preferably, the storage arrangement 226 comprising a plurality of decentral storage units 228 may be formed as a decentral file system (such as IPFS) or a decentral object store (such as storj) or a decentral distributed database (such as BigchainDB) controlled by the peer-to-peer application 222.

In a further embodiment an (not shown) analysis means may conduct processes e.g. by accessing the storage 226. Access can be granted based on an access transaction agreement controlled by the peer-to-peer application 222 (e.g. via a smart contract). The analysis means may be executable upon an analysis request message. The analysis means may comprise algorithm(s) for processing data stored in the storage 226.

In other embodiments, the peer-to-peer application can comprise a registry storage.

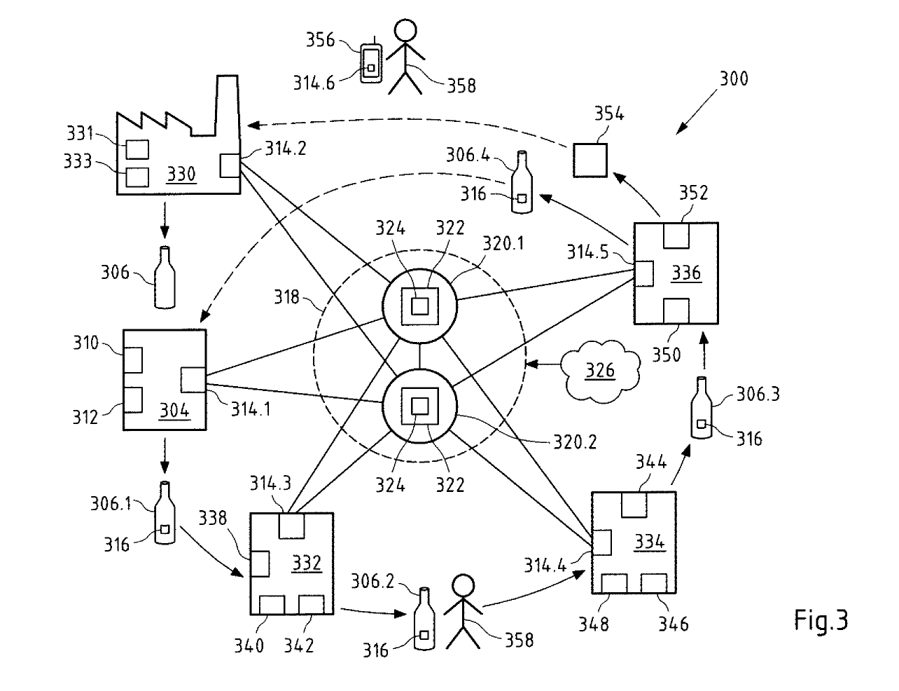

FIG. 3 shows a schematic view of a further embodiment of a raw material and/or recycling system 300. In the present example, the recyclable material element 306 is a container 306 e.g. in form of a bottle 306 or the like. The depicted recyclable material element processing units 304, 330, 332, 334, 336 are configured to process a container 306, as will be described hereinafter. However, the present embodiment can be easily transferred and e.g. adapted to any other kind of recyclable material elements and respective recyclable material element processing units needed to process said recyclable material elements.

The depicted system 300 comprises a peer-to-peer network 318 with a plurality of nodes 320.1, 320.2 (for sake of clarity, only two nodes are depicted). Each of the depicted nodes 320.1, 320.2 comprises a peer-to-peer application 322 having at least a registering means 324, as described hereinbefore.

Furthermore, the system 300 comprises a plurality of recyclable material element processing units 304, 330, 332, 334, 336. It shall be understood that there may be more or less recyclable material element processing units.

In the present embodiment, each of the recyclable material element processing units 304, 330, 332, 334, 336 comprises a peer-to-peer module 314.1, 314.2, 314.3, 314.4, 314.5 configured to communicate with the peer-to-peer application 322. It shall be understood that it is also possible that a peer-to-peer module is shared by two or more recyclable material element processing units and/or that a recyclable material element processing unit comprises two or more peer-to-peer modules. Preferably, each of the recyclable material element processing units 304, 330, 332, 334, 336 can comprise a (not shown for sake of clarity) reading tool, respectively, for detecting or reading out an identifier of a container 306 to 306.4.

Further, in the present embodiment, each of the recyclable material element processing units 304, 330, 332, 334, 336 comprises at least one status detecting tool 312, 333, 338, 344, 350. As described hereinbefore, a status detecting tool may be also (implicitly) integrated in another tool 331, 310, 338, 344, 350 of a respective recyclable material element processing unit 304, 330, 332, 334, 336.

A first recyclable material element processing unit 330 may be a production unit 330. The production unit 330 of a production entity (e.g. fabric) may comprise one or more producing tool(s) 331 configured to produce one or more container(s) 306. A produced container 306 can be forwarded to a further recyclable material element processing unit 304 in form of a tagging unit 304. It shall be understood that the tagging unit 304 can be part of the production unit 330 or of a filling system configured to fill the container with e.g. a liquid to be consumed.

As described above, the tagging unit 304 may comprise a tagging tool 310 configured to provide an identifier to a container 306.1, e.g. by attaching a code element 316 having the unique identifier to the container 306.1. Attaching can include integrating the coding element 316 in e.g. a wall or bottom of the container 306 or mounting the coding element 316 at a wall or bottom of the container 306 e.g. by gluing or the like.

The first peer-to-peer module 314.1 may provide the identifier and a first status parameter data set (e.g. ‘used’ or ‘unused’, location, time-stamp, identifier of the tagging unit 304, etc.) to the peer-application 322. Then, the registering means 324 may be executed to register the container 306.1 by storing the received identifier and the first status parameter data set.

A further peer-to-peer module 314.2 to 314.5 may provide a further status parameter data set (e.g. ‘newly produced’, identifier of the production unit 330, identifier(s) of the used production tool(s), etc.) and, preferably, at least one treatment parameter data set to the peer-to-peer application 322. A treatment parameter data set can comprise information about the used starting material(s) of a produced container 306 (e.g. chemical formula of each starting material/ingredient and their respective portion (e.g. percent by weight)), decomposition rule(s), allowed decomposition physical, chemical or biological processes, treating rule(s) or parameter(s), such as maximum allowed (cleaning) temperature, allowed cleaning material(s), physical material storage or transportations rules (e.g. for sensible or dangerous materials), etc. The registering means 324 can associate the received data set to the respective container 306.1 by means of the identifier of the container 306.1 and can store said additional data together with the identifier in the registry storage e.g. formed by a storage arrangement 326, as described above.

It shall be understood that the tagging unit can be part of the production unit and production chain, respectively.

In the present embodiment, one or more container(s) 306.1, which might be filled with a liquid (e.g. water, beer, etc.), can be forwarded to a delivery unit 332 (e.g. using transport units).

The delivery unit 332, e.g. a shop or a beverage dispenser, may be configured to deliver/dispense a container 306.2 to a recipient 358, e.g. a user 358. Other recyclable material elements might be also dispensed to a machine. For instance, the delivery unit 332 comprises a dispensing tool 340 configured to dispense a container 306.2. Further, the delivery unit 332 comprises a recipient identifier detecting tool configured to detect an identifier assigned to a recipient 358 (byer). The identifier may be a ticket identifier of the recipient 358, an identifier of the recipient registered in the peer-to-peer application 322 (or a wallet ID), a credit card number or the like. Besides a current status parameter data set comprising, e.g. ‘sold’, identifier of the delivery unit 332, location of the delivery unit 332, time stamp and/or the identifier of the container 306.2, the identifier of the recipient 358 can be provided to the peer-to-peer application 322 and stored, as described hereinbefore. The identifier of the recipient 358 might be used for at least one accounting process, as will be described hereinafter.

Furthermore, an empty (and thus used/consumed) container 306.2 can be returned at a return unit 334, such as a shop or a return machine. In a preferred embodiment, the return unit 334 may be a (smart) waste bin 334. The return unit 334 can have a receiving tool 346 for receiving a container 306.2 and an optional recipient identifier detecting tool 348.

For instance, if the (used) container 306 is retuned using the receiving tool 346 the identifier of the returned container can be detected. The identifier of the returned container 306.3 can be provided from the peer-to-peer module 314.4 to the peer-to-peer application 322. For instance, upon receipt of an identifier of the returned container 306.3, a (not shown) accounting means can be executed by a part of the nodes 320.1, 320.2. The accounting means may be configured to conduct an accounting process e.g. based on the identifier of the returned container 306.3 and a corresponding delivery transaction agreement, as will be described hereinafter.

The status detecting tool 344 may be configured to detect whether the returned container comprises crack(s), dirt particle(s), weight of the container or other undesired element(s) or conditions or the like. The peer-to-peer module 314.4 is configured to transmit the previously described data to the peer-to-peer application 322. The registering means 324 may store said data in the registry storage of the storage arrangement 326, as described above. Algorithms can be run on top of the data stored in the storage arrangement 326. The current status parameter data set of a returned container 306.3 may be taken into account by an accounting means based on a stored delivery transaction agreement.

The returned container 306.3 can be forwarded to a recycling unit 336 (e.g. by transporting units). The recycling unit 336 may have one or more recycling tools 352. For instance, a recycling tool 352 may be a cleaning tool configured to clean a used/returned container 306.3. Preferably, the peer-to-peer module 314.5 is configured to receive a treatment parameter data set related to the container 306.3 to be cleaned. For instance, a reading tool of the recycling unit 336 can detect the identifier of the container 306.3 to be cleaned. The detected identifier can be provided to the peer-to-peer application 322 by sending a treatment parameter request message by the peer-to-peer module 314.5. The peer-to-peer application 322 may comprise a (not shown) retrieving means configured to retrieve the treatment parameter data set stored in the registry storage and corresponding to the received identifier. Then, the retrieved treatment parameter data set can be provided to the requesting peer-to-peer module 314.5.

In a further embodiment the recycling unit 336 may store recycling and treatment process data sets about the recycling process or recycling tool activities in the peer-to-peer application 322 (e.g. material input parameters, treatment parameters, material output parameters). The recycling and treatment process data sets can be used for reporting purposes, optimization purposes or for analytical purposes.

It shall be understood that a recycling unit may have one or more (different) recycling tool(s).

Then, the recycling tool 352 can be (automatically) operated at least based on the received treatment parameter data set e.g. comprising allowed (and/or optimal) cleaning agent(s), maximum allowed (and/or optimal) cleaning temperature, or any other physical, chemical, biological treatment rules, etc.

Another example of a recycling tool 352 may be a tool for regaining the used starting materials 354 from the used container 306.3 e.g. by a heating and sorting process. Such a tool may (also) be operated at least based on the received treatment parameter data set e.g. comprising the originally used starting material, weighting specifications (e.g. percent by weight), etc.

Status parameter data, such as ‘cleaned’, location, time stamp, identifier of the unit and/or tool(s), etc. can be forwarded to the peer-to-peer application 322 by the peer-to-peer module 314.5 and stored, as described hereinbefore. A cleaned container 306.4 can e.g. be forwarded to the tagging unit e.g. in order to re-register the container 306.4 or to a filling station (then the same code element and identifier, respectively, can be maintained). A regained starting material 354 can e.g. be forwarded to the production unit 330 in order to produce a new container 306.

Furthermore, an entity 358, 356 can get access to data stored in the registry storage. The access to the data can be controlled by the peer-to-peer application 322. For instance, a computing entity 356 (e.g. a mobile phone 356) comprising a peer-to-peer module 314.6 can send an access request message comprising e.g. a recipient identifier and/or a container identifier. Based on the received identifier(s) and e.g. based on predefined access rule(s), the peer-to-peer application 322 (e.g. by means of an access means) may allow or deny access to the desired data which might be also specified in the access request. Thereby, a user (e.g. customer) 358 can track the way (e.g. life cycle) of the container e.g. used by him from the production to recycling of said container.

It shall be understood that there may be several intermediate units, such as transport units, storage units and the like. In a preferred embodiment, also these units can comprise a peer-to-peer module and one or more status detecting tool(s), in particular, configured to detect one or more current status parameter(s) of the container(s). The respective peer-to-peer modules may be configured to transmit the respective status parameter data sets and the respective (read out) identifier(s) of the container(s) to the peer-to-peer application 322 in order to log this data in the registry storage by the registering means 324.

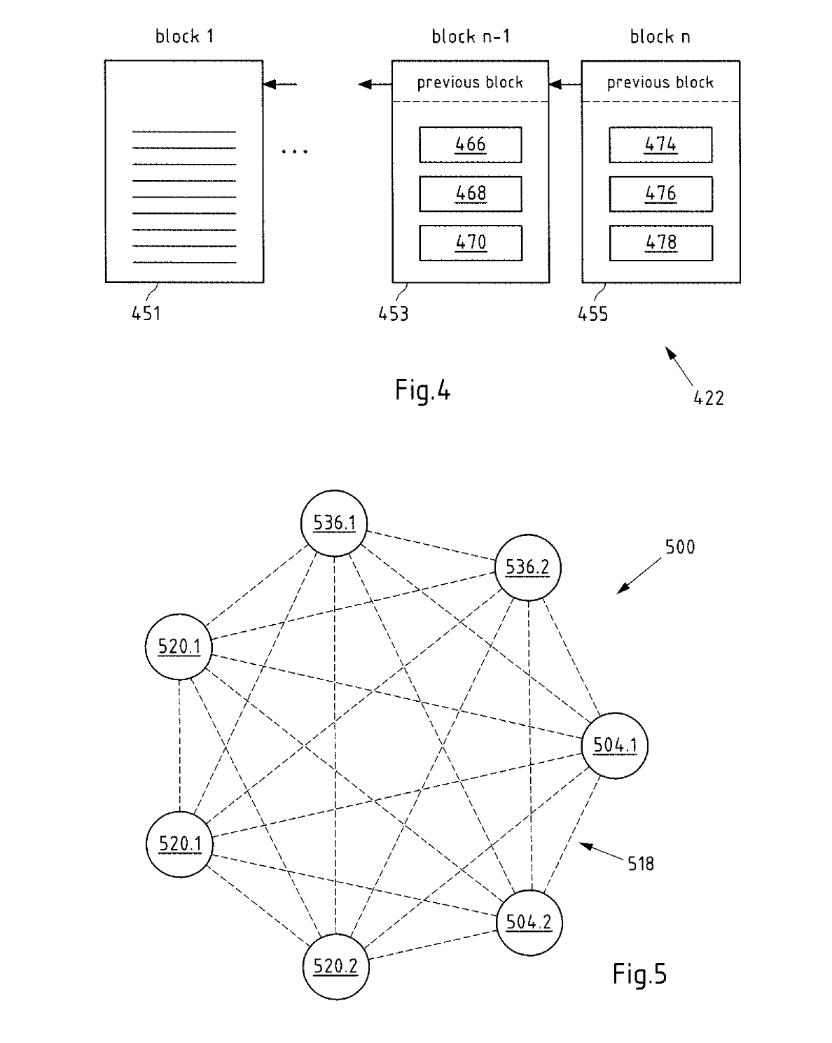

FIG. 4 shows a schematic view of an embodiment of a peer-to-peer application 422 according to the present application.

The depicted peer-to-peer application 422 is a register readable, in particular, by the participants of the peer-to-peer network. Thereby, data set(s) e.g. in form of messages can be written and/or read into/from the register 422 by a peer-to-peer module assigned to a recyclable material element processing unit and/or any other participants in the peer-to-peer network. In a preferred embodiment, the peer-to-peer application 422 may be a block chain 422.

Hereinafter, it is assumed in the following description of the present embodiment that the at least one peer-to-peer application 422 is a block chain 422. However, the following remarks can be easily transferred to other peer-to-peer applications, such as a Directed Acyclic Graph (DAG). A directed acyclic graph, such as IOTA or Tangle, means that blocks (or nodes of the graph) are coupled to each other via directed edges. Thereby, direct means that the (all) edges have (always) a same direction similar to time. In other words, it is not possible to step back. Eventually, acyclic means that loops do not exist.

In further embodiments of the peer-to-peer application, the block chain can be a permissionless or permissioned block chain. In a specific case the block chain can be public, consortium or private block chain.

In a further embodiment, the peer-to-peer application can be formed with multiple block chains which are connected via mechanisms, such as side chains or smart contracts. Interoperability among block chains can be established.

The block chain 422 is formed by at least one block 451, 453, 455, preferably by a plurality of interconnected blocks 451, 453, 455. The first block 451 may also be called genesis block 451. As can be seen, a block 453, 455 (except for the first block 451) refers to each previous block 451, 453. A new block can be created by a computationally intensive process (for example, so called “mining” or through another appropriate process, such as voting) and will be particularly provided to all participants of the peer-to-peer network.

The present block chain 422 is particularly adapted to receive messages, such as messages comprising an identifier (provided to a recyclable material element or detected from a recyclable material element) and/or status parameter data set(s), treatment parameter data set(s), authentication result(s), etc., from a peer-to-peer module of a previously described recyclable material element processing unit, (off-chain) computing entity or from another peer-to-peer device/unit of another participant of the peer-to-peer network. Further, the block chain 422 is particularly adapted to save these messages in the block chain 422. Furthermore, the block chain 422 is configured to generate messages e.g. based on a registering process, accounting process, retrieving process and/or caused by a peer-to-peer module and/or the execution of code of e.g. a registering means 466, an accounting means 468, etc. In particular, the block chain 422 is at least configured to control and manage a raw material and/or recycling system, such as shown in FIG. 2 or 3.

In particular, a (newly) received message can be saved and published in the current block 455 of the block chain 424. Due to the configuration of a block chain 424 as a public register 424, said data message of e.g. a peer-to-peer module can be read by preferably all participants of the peer-to-peer network. Alternatively or additionally, data of a message may be stored in a registry storage e.g. on a decentral file service or distributed block chain database controlled by the block chain 422.

As already described, in the present block chain 422 different types of messages and data sets, respectively, for example, within a smart contract (algorithm and/or storage at the block chain 422) can be processed and/or stored. In the present example, the block chain 422 comprises a registering means 466 in form of a smart contract 466. As previously described, the registering means 466 may be configured to at least register at least one recyclable material element in the raw material and/or recycling system.

Furthermore, in the block chain 422 one or more delivery transaction agreement(s) 470 may be stored. A delivery transaction agreement 470 may be generated between at least one provider of a recyclable material element and a recipient of the recyclable material element in order to define and store the details about the dispense, use and/or return of a (used) recyclable material element. An example of a generation of such a delivery transaction agreement 470 will be described in the following:

A delivery transaction agreement 470 may comprise at least one of the following data:
Identifier(s): Identifier of the dispensed recyclable material element; identifier of the recipient; identifier of a provider.
Delivery/return transaction criterion(s): Criterion(s) that must be fulfilled for allowing a dispense of a recyclable material element (e.g. deposit, consumption fee) or for a return of a deposit (e.g. a specific status parameter data set of the returned recyclable material element).
Operating detail(s): Detail(s) about delivery and/or return, such as return time, return location, etc.

The delivery transaction criterion may be an amount of cryptocurrency for a temporarily use/consumption of a recyclable material element, an use/consumption e.g. of a content (e.g. beverage) of a recyclable material element or the like. Another delivery transaction criterion may be a deposit for the use of the recyclable material element. Another delivery transaction criterion may be a specific status parameter data set of the returned recyclable material element. It may be possible that an amount has to be transferred prior to, during and/or after the use/consumption.

Preferably, at least a part of the said amount of cryptocurrency can be locked by the peer-to-peer application 422 prior to dispensing a recyclable material element e.g. as a deposit. In an embodiment, the delivery transaction criterion may be a payment channel for streaming small amounts of crypto tokens per each time and/or data unit. It shall be understood that other transaction criteria and further information can be included in an delivery transaction agreement. More information/criteria can be, for example, a time stamp, an ID of the transaction and the like.

In order to generate a delivery transaction agreement 470, a peer-to-peer module of a delivery unit can transmit a request message 472 to the peer-to-peer application comprising an identifier of a recyclable material element to be dispensed and a recipient identifier. The peer-to-peer application 422 (e.g. according to predefined rule(s)) or a peer-to-peer module of a provider of the recyclable material element and/or the content of the recyclable material element can transmit a response (acceptance) messages via the peer-to-peer application 422. A request message 472 may comprise indications about the above data (identifications, delivery/return transaction criteria, etc.). Prior to generating a delivery transaction agreement 470, an authentication process for checking the authentication of the recipient can be conducted. After a positive result, the process for generating the agreement 470 can be continued.

Another message 474 may be an acceptance message 474 of e.g. a provider or peer-to-peer application. An acceptance message 474 may comprise identical or at least similar data details as compared with a request message 472. Additionally, the acceptance message 474 can comprise a reference indication to a previous message, such as the ID of the message 472. The acceptance message 474 can be provided by a peer-to-peer module of a provider or by the peer-to-peer application (e.g. according to preset rules).

If, for example, the acceptance message 474 comprises a higher or other further transaction criterion and/or other desired operational detail(s), the acceptance message 474 can be called a counter-offer message. This can be accepted by the peer-to-peer module of the dispensing unit (e.g. after a further inquiry) through an acceptance message.

A further message can an analysis request message 478 to get access to data stored in a storage arrangement 476. Analysis requests messages can be checked against registered units with the respective access rights to access data in a storage arrangement.

In particular, there can be multiple request messages and/or accepting messages. Each entity (recipient) and unit can give guidelines, according to which at least one delivery transaction agreement 470 or other agreements can be generated. In a preferably automated, such as iterative process, each request/offer message can be associated to an optimally corresponding acceptance message. The block chain 422 may be configured to generate, based on the messages of a peer-to-peer module, a delivery transaction agreement 470.

Moreover, a block chain 422 may comprise a further registering means (not shown) configured to register a (new) entity, recyclable material element processing unit, recipient, etc. in the block chain 422 as a smart asset.

FIG. 5 shows a schematic view of a further embodiment of a system 500 of the present application. In the present embodiment, only nodes and participants 504.1, 504.2, 520.1, 520.2, 536.1, 536.2 of the peer-to-peer network 518 are shown. In the present example, it is assumed that all nodes participants 504.1, 504.2, 520.1, 520.2, 536.1, 536.2 comprise the peer-to-peer application (not shown).

The nodes 504.1, 504.2 may correspond to tagging units and e.g. be formed by the respective first peer-to-peer modules of tagging units. The nodes 536.1, 536.2 may correspond to recycling units and e.g. be formed by the respective peer-to-peer modules of recycling units. Nodes 520.1 and 520.2 may be other nodes. It shall be understood that nodes can be full, remote or light nodes.

As can be seen, two different types of peers or node computers 504.1, 504.2, 520.1, 520.2, 536.1, 536.2 are presently illustrated. All 504.1, 504.2, 520.1, 520.2, 536.1, 536.2 are comprised by the peer-to-peer network 518. In the present embodiment, however, only a part of the nodes 504.1, 504.2, 520.1, 520.2, 536.1, 536.2 in the present case, the peers (nodes) 504.1, 536.1, 520.1 may execute a registering means and may check the validity of e.g. a message received by the peer-to-peer-application and/or the validity of further data stored in the peer-to-peer application, such as agreements, status parameter data set(s), and the like.

Furthermore, only a part of the entire peers can be configured to store the peer-to-peer application and/or only a part of the peers can be configured to execute the algorithms of a smart/private contract. Since the validation/verification of e.g. identification data requires a considerable computational effort, it may be advantageous for reasons of efficiency, if only a part of the nodes 504.1, 536.1, 520.1, especially particularly powerful nodes 504.1, 536.1, 520.1 perform the execution of executable means and/or validation algorithm(s) and/or authentication algorithm(s).

Validation, analytics and optimization can be done on-chain or off-chain, as described hereinbefore. Off-chain validation, analysis and/or optimization can be managed by the peer-to-peer application, like the code on the block chain. Powerful means, in particular, a high computing power. In other words, in the present case a valid entry in the peer-to-peer application, such as a block chain, is assumed if (only) a part of the peers 504.1, 536.1, 520.1 comes to a positive result. It shall be understood that only a single, especially particularly powerful peer can perform the validation, analytics and/or optimization process while further nodes may be configured as monitoring nodes.

Similarly, in a further (not shown) embodiment, a particularly large peer-to-peer network may be divided in two or more clusters. In a corresponding peer-to-peer network, for example, a validation will only be carried out by the members of one cluster (e.g. sharding of a block chain to improve the scalability). In a further embodiment, the peer-to-peer application can be formed using multiple block chains. These block chains are connected via frameworks such as sidechains or smart contracts or interlegder.

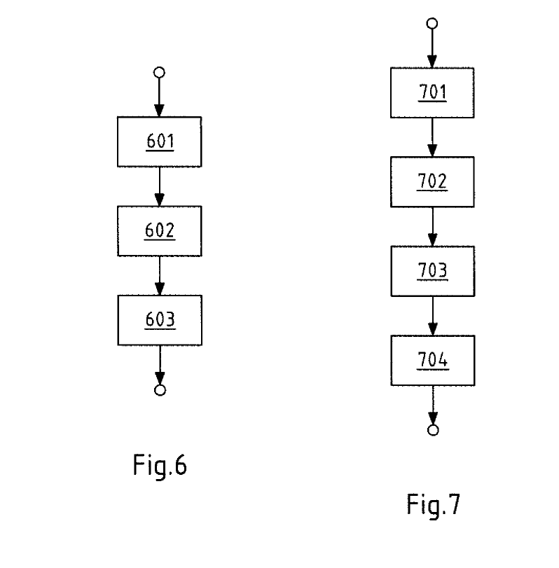

FIG. 6 shows a diagram of an embodiment of a method according to the present application. The method can be used e.g. for operating a previously described system 200, 300 or 500.

In a first step 601, an (unique) identifier is provided to a recyclable material element. Preferably, a code element comprising said identifier is attached to the recyclable material element. It may be also possible that an identifier is written into a memory of an already attached code element or the identifier may be generated by a crypto ID chip of a code element and written into the peer-to-peer application. It may be also possible that a (second) identifier and a digital product memory may be set-up in the peer-to-peer application. Identifier in the code element and in the peer-to-peer application might be mapped via the registry storage. The identifier can be provided to the peer-to-peer application by means of a first peer-to-peer module. Then, in step 602, at least one status parameter can be at least implicitly detected. The detected status parameter can be provided to the peer-to-peer application e.g. by sending a status parameter data set comprising at least said detected status parameter. Steps 601 and 602 may be conducted at least partly in parallel.

Further, in step 603, the recyclable material element is registered in the peer-to-peer application and system, respectively. In particular, the peer-to-peer application may comprise at least one registering means executable by at least a part (e.g. >1) of the nodes of the peer-to-peer application. By executing the registering means, at least the provided identifier and the provided status parameter data set are stored in at least one (updateable and/or inspectable) registry storage at least controlled by the peer-to-peer application.

FIG. 7 shows a diagram of a further embodiment of a method according to the present application. The method can be used e.g. for operating a previously described system 200, 300 or 500.

In a first step, a delivery or dispense of a recyclable material element, e.g. a container having a specific content, can be detected and registered by means of the peer-to-peer application. For instance, the peer-to-peer application can receive a message from a delivery unit, wherein the message comprises at least one of:
identifier of the delivered recyclable material element,
identifier of the recipient of the delivered recyclable material element.

Further data, such as status parameter(s), can be included in the message.

In step 702, an accounting process can be conducted. For instance, the peer-to-peer application can comprise at least one accounting means. For instance, the accounting process can be conducted based on a delivery transaction agreement comprising e.g. two delivery/return transaction criterions (e.g. a price for (temporarily) using the recyclable material element or consuming e.g. its content and a deposit for the recyclable material element).

While during the accounting process the first amount of e.g. cryptocurrency can be transferred from an account of the recipient (at least based on the received recipient identifier) to an account of the provider of the recyclable material element (e.g. based on the received identifier of the recyclable material element), a deposit in form of cryptocurrency can be merely locked by the accounting means. It shall be understood that the deposit can also be transferred. In an embodiment, the at least one transaction criterion may be a payment channel for streaming small amounts of crypto tokens per each time and/or data unit. It shall be understood that other transaction criteria and further information can be included in a delivery transaction agreement. More information/criteria can be, for example, a time stamp, an ID of the transaction and the like.

In step 703, a return of the recyclable material element can be detected and registered by means of the peer-to-peer application. For instance, a return unit, such as a smart bin, can detect an identifier of a returned recyclable material element. The return unit can transmit a message to the peer-to-peer application, wherein the message comprises at least the identifier and an information about the return of the recyclable material element. Further data, such as status parameter(s), can be included in the message. Upon receipt of such a message, the registering means can detect and register the return of the recyclable material element, as described above.

In step 704, a further accounting process can be conducted. In particular, according to a delivery transaction agreement comprising a transaction criterion in form of a deposit, the deposit can be unlocked and/or retransferred to the account of the recipient. In order to determine the correct recipient, based on the received identifier of the recyclable material element, the recipient identifier (and e.g. its account data) can be retrieved from the registry storage.

It may be possible that the full deposit is only returned if the status of the returned recyclable material element meets predefined requirement(s). Otherwise, only a part or none of the deposit might be returned.

It may also be possible to run analytical algorithms on the data stored in the peer-to-peer application at any process step.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A raw material and/or recycling system, comprising:
at least one tagging unit configured to provide at least one recyclable material element with at least one identifier,
at least one first peer-to-peer module assigned to the tagging unit,
at least one peer-to-peer network comprising at least one peer-to-peer application,
wherein the first peer-to-peer module is configured to provide the provided identifier and at least one status parameter data set related to the recyclable material element to the peer-to-peer application,
wherein the peer-to-peer application comprises at least one registering means executable upon provision of the provided identifier by at least a part of the nodes of the peer-to-peer network,
wherein the registering means is configured to register at least the recyclable material element by storing at least the provided identifier and the provided status parameter data set in at least one registry storage and to monitor the registering process by executing the registering means by at least two nodes of the peer-to-peer network.

2. The system according to claim 1, wherein the tagging unit comprises at least one tagging tool configured to attach at least one readable code element comprising the identifier to the recyclable material element, and/or
wherein the tagging unit comprises at least one status detecting tool configured to detect at least one status parameter related to the recyclable material element.

3. The system according to claim 1, wherein the system further comprises:
at least one further recyclable material element processing unit,
wherein the recyclable material element processing unit comprises at least one of a further status detecting tool and a reading tool configured to detect the identifier provided to the recyclable material element, and
at least one further peer-to-peer module assigned to the further recyclable material element processing unit and configured to provide at least the detected identifier and at least one further status parameter data set to the peer-to-peer application.

4. The system according to claim 1, wherein the peer-to-peer application is configured to receive at least one treatment parameter data set related to the recyclable material element,
wherein the registering means is further configured to store at least one treatment parameter data set related to the recyclable material element together with the identifier of the recyclable material element in the registry storage.

5. The system according to claim 4, wherein the system further comprises:
at least one recycling unit comprising at least one recycling tool configured to process a provided recyclable material element during at least one recycling step,
wherein a further peer-to-peer module assigned to the recycling unit is at least configured to receive the stored treatment parameter data set related to the recyclable material element from the peer-to-peer application, and
wherein at least the recycling tool is configured to process the recyclable material element at least based on the received treatment parameter data set.

6. The system according to claim 1, wherein the system further comprises:
at least one delivery unit comprising at least one dispensing tool configured to dispense at least one recyclable material element to at least one recipient,
wherein the delivery unit comprises at least one recipient identifier detecting unit configured to detect at least one recipient identifier assigned to the recipient of the dispensed recyclable material element,
wherein a further peer-to-peer module assigned to the delivery unit is at least configured to provide the recipient identifier and the identifier of the dispensed recyclable material element to the peer-to-peer application.

7. The system according to claim 6, wherein the peer-to-peer application is configured to generate a delivery transaction agreement about the delivery and/or return of a recyclable material element between a providing entity and the recipient at least based on the recipient identifier.

8. The system according to claim 7, wherein the generated delivery transaction agreement comprises at least the recipient identifier, the identifier of the recyclable material element and at least one delivery/return transaction criterion.

9. The system according to claim 8, wherein the system further comprises:
at least one return unit comprising at least one receiving tool configured to receive at least one recyclable material element,
wherein a further peer-to-peer module assigned to the return unit is at least configured to provide the identifier of the returned recyclable material element to the peer-to-peer application.

10. The system according to claim 9, wherein the peer-to-peer application comprises at least one accounting means,
wherein the accounting means is executable upon provision of the provided identifier of the returned recyclable material element, and
wherein the accounting means is at least configured to conduct an accounting process based on the provided identifier of the returned recyclable material element and at least one delivery transaction criterion stored in the delivery transaction agreement.

11. The system according to claim 1, wherein the peer-to-peer application is a decentralized register or a shared database, and
wherein data is stored by the peer-to-peer application with given certain proofs or signatures.

12. The system according to claim 1, wherein the at least one peer-to-peer application is a block chain or decentral ledger comprising at least two blocks coupled to each other.

13. A recyclable material element processing unit for a raw material and/or recycling system, in particular, a raw material and/or recycling system according to claim 1, the unit comprising:
at least one status detecting tool configured to detect at least one status parameter related to at least one recyclable material element,
at least one reading tool configured to detect an identifier provided to the recyclable material element, and
at least one peer-to-peer module configured to provide at least the detected identifier and at least one status parameter data set comprising at least the detected status parameter to at least one peer-to-peer application of at least one peer-to-peer network such that the identifier and the status parameter data set are stored in at least one registry storage by at least one registering means of the peer-to-peer application, wherein the registering means is executed by at least two nodes of the peer-to-peer network, wherein the registering process is monitored by executing the registering means by the two nodes.

14. A method for operating a raw material and/or recycling system, in particular, a raw material and/or recycling system according to claim 1, the method comprising:
providing at least one recyclable material element,
providing at least one identifier to the provided recyclable material element, and
registering the recyclable material element by storing at least the provided identifier and the provided status parameter data set in at least one registry storage by means of at least one registering means of at least one peer-to-peer application of at least one peer-to-peer network,
wherein the registering means is executed upon provision of the provided identifier by at least a part of the nodes of the peer-to-peer network, wherein the registering means is executed by at least two nodes of the peer-to-peer network, and wherein the registering process is monitored by executing the registering means by the two nodes.

15. A peer-to-peer application of at least one peer-to-peer network, comprising:
at least one registering means configured to register at least one recyclable material element by storing at least one received identifier of the recyclable material element and at least one received status parameter data set related to the recyclable material element in at least one registry storage controlled by the peer-to-peer application, wherein the registering means is executed by at least two nodes of the peer-to-peer network, and wherein the registering process is monitored by executing the registering means by the two nodes.
